(19) United States
(12) Patent Application Publication
(10) Pub. No.: US 2005/0229762 A1
(43) Pub. Date: Oct. 20, 2005

(54) Cnc slitter machine

(75) Inventors: Patrick M. Flaherty, Kettering, OH (US); Rick L. Ahrns, New Bremen, OH (US); Charles G. Rutschilling, St. Henry, OH (US); Kenneth A. Balster, New Bremen, OH (US); Xingyun Qu, Piqua, OH (US)

Correspondence Address: Thomas J Edgington;Kirkpatrick & Lockhart, Henry W Oliver Building, 535 Smithfield Street, Pittsburgh, PA, 15222-2312, US

(73) Assignee: BLUE IP, INC., Callery, PA (US)

(21) Appl. No.: 10/515,521

(22) PCT Filed: May 30, 2003
(86) PCT No.: PCT/US03/17107

§ 371 Date: May 23, 2005

Related U.S. Application Data
(60) Provisional application No. 60/384,600, filed on May 30, 2002.

(51) Int. Cl. B26D 1/04

(52) U.S. Cl. 83/499; 83/508.3

(57) ABSTRACT

A machine (100) for slitting a metal sheet has a number of knife assemblies (112) each containing a rotary knife (110). The knife assemblies (112) are mounted for movement along upper and lower arbors (104, 106) which rotate the knives (110) during a slitting operation. Upper and lower knife assembly positioning devices (114) are operable to releasably grasp the knife assemblies (112) for movement of the knife assemblies (112) to predetermined positions along the upper and lower arbors (104, 106).

The present application claims the filing benefit of pending U.S. Provisional Application Ser. No. 60/384,600, filed May 30, 2002, the disclosure of which is hereby incorporated herein by reference in its entirety.

### FIELD OF THE INVENTION

The present invention relates generally to slitter machines for slitting sheet metal into “mults” or strips and, more particularly, to slitter machines having adjustable knives for varying the size and/or number of mults processed by the slitter machine.

### BACKGROUND OF THE INVENTION

Much of the steel produced by mills Is In the form of coiled steel sheet, but rarely does the sheet correspond in width to the multitude of products that are stamped or otherwise formed from it. Accordingly, the steel sheet is usually slit longitudinally to sizes suitable for the particular products. Indeed, special slitting machines are made for this purpose.

The typical slitting machine has circular blades or knives arranged in pairs on two powered shafts or arbors, there being one knife of each pair on one of the arbors and the second knife of the pair on the other arbor. The arbors are connected to motors for counter-rotation. During operation, sheet metal is moved between the arbors and cut into mults by the knives counter-rotating on the arbors. Actually each knife is nothing more than a hardened steel disk having flat end faces and a cylindrical peripheral face which intersects the end faces at relatively sharp cutting or shearing edges. The disks of each pair are positioned on their respective arbors, often with a slight overlap. Overlap or not, the knives of each pair are positioned close enough to each other to enable them to cut or shear the metal sheet as it passes between those knives. In other words, the metal sheet is drawn between the two knives of a pair the disk-like knives shear the sheet along the opposite cutting edges, thus producing a clean longitudinal cut In the sheet. Not only are the disk-like knives arranged in pairs, but the pairs of knives are also usually organized Into left and right hand configurations to prevent the longitudinal segments of the slit sheet from acquiring a twist or spiral upon emerging from the slitting machine.

The size of the mults is determined by the spacing of the knives on the arbors. The knives, while being fixed firmly on their respective arbors during the operation of the machine, nevertheless may be removed for sharpening or may be repositioned so that the width of the segments slit may be varied. Setting the knives on the arbors of a slitting machine however is a tedious and time-consuming procedure, requiring a high degree of skill, for the knives must be located with considerable precision, not only to acquire the proper width for the cut, but to also maintain a clean high quality cut as well.

In one type of slitting machine, the knives are carried on hubs that slide over the arbor and are secured with set screws in the desired positions. To set the knives of a pair in the proper position, the location of the cut desired from the pair of knives is usually located by measuring with a tape measure from reference point on the machine. One of the knives is then moved over its arbor to the point located with the tape measure and the set screw of its hub is turned down to secure the knife. Once the knife is so positioned, an Indicator gage should be brought against it while the arbor is turned slowly. With the Indicator gage the knife is checked for wobble and usually adjustments must be made by loosening the set screws and tapping the knife lightly to eliminate the wobble. The same procedure is then repeated with the other knife of the pair, only Its location is determined from the location of the previous knife, there usually being an axial gap on the order of 7 to 10 percent of the thickness of the metal sheet between the opposite cutting edges of the two knives. To change the size and number of mults produced from the sheet metal, the hubs must be released from the arbors and moved to new locations. New hubs would be added, or existing hubs removed, as dictated by changes in the number of mults to be cut in the sheet metal.

In another type of slitting machine, spacers separate the knives. These spacers are large enough and are machined with enough precision to minimize the wobble inherent with conventional slip arbors, but present complexities in the selection of spacers and shims to properly locate the knives. The selection of spacers and shims requires a considerable amount of skill. Furthermore, the spacers must be handled carefully, to avoid nicks that will skew the knives and create a wobble as they rotate.

To change the size and number of mults produced from the sheet metal, the spacers must be removed from the arbor and replaced with a new set of spacers adapted to the new cutting pattern.

In the past, such replacements and adjustments were generally performed by hand. This use of manual labor was expensive and slowed the process of conversion from one cutting job to the next. The task of replacement and adjustment was difficult physically, often requiring workers to lift the heavy hubs or spacers to uncomfortable heights. Furthermore, where spacers were used, it was necessary to maintain a sizable inventory of such spacers to provide flexibility in cutting different sizes and numbers of mults.

One prior attempt to solve such problems is disclosed in U.S. Pat. No. 4,887,502 directed to a machine for slitting metal. The machine includes upper and lower powered arbors and also upper and lower storage arbors which align respectively with the upper and lower powered arbors. Each powered arbor supports and turns several knives which are mounted on hubs along those arbors, and these knives when not needed may be moved, along with their hubs, onto the aligned storage arbors. Each knife is captured in a carriage which moves along one of the beams. The knives are positioned through a lead screw which drives a carriage having stops against which knives on the upper and lower arbors are manually moved and set in position through contact with the stops. The carriage may also be provided with fingers which actually capture the knives of a pair and move them to the correct position.

To eliminate the need to reconfigure a slitting machine for a particular slitting operation, a slitting line may include multiple slitters having different knife configurations that can be moved into and out of the line.

There remains a need in the art for slitting machines which can be automatically set up and adjusted, including the replacement or servicing of knives on the arbors, with minimal labor on the part of the operator or user.

### SUMMARY OF THE INVENTION

The present invention overcomes the foregoing and other shortcomings and drawbacks of slitting systems and methods of slitting heretofore known. While the Invention will be described in connection with certain embodiments, it will be understood that the invention is not limited to these embodiments. On the contrary, the invention Includes all alternatives, modifications and equivalents as may be included within the spirit and scope of the present invention.

In accordance with the principles of the present invention, a slitting machine is provided having a frame which supports upper and lower arbors which are mounted for rotation in the frame. A drive motor is operatively coupled to the upper and lower arbors to rotate the arbors during a slitting operation.

In accordance with one aspect of the present invention, a plurality of knife assemblies are supported for movement along the upper and lower arbors such that a first knife assembly is supported for movement along the upper arbor and a second knife assembly is supported for movement along the lower arbor. A plurality of rotary knives are each mounted in a respective one of the knife assemblies and are driven by one of the upper and lower arbors. The rotary knives of the first and second knife assemblies cooperate to slit the metal sheet passing through a nip between the knives of the respective knife assemblies.

The slitting machine of the present invention includes an upper knife assembly positioning device which Includes a pair of oppositely disposed contact members that are operable to releasably grasp each of the first knife assemblies for movement of the first knife assemblies along the upper arbor, and a lower knife assembly positioning device which includes a pair of oppositely disposed contact members that are operable to releasably grasp each of the second knife assemblies for movement of the second knife assemblies along the lower arbor.

A first drive mechanism associated with the upper knife assembly positioning device is operable to move the first knife assemblies along the upper arbor and a second drive mechanism associated with the lower knife assembly positioning device is operable to move the second knife assemblies along the lower arbor.

The machine advantageously includes a programmable logic controller that is electrically coupled to the first and second drive mechanisms associated with the upper and lower knife assembly positioning devices. The programmable logic controller, in combination with the upper and lower knife assembly positioning devices associated with the knife assemblies, positions the knife assemblies along the upper and lower arbors and secures the knife assemblies in place at predetermined positions for rotation of the knives with the upper and lower arbors. A presently preferred machine is capable of cutting from one-to-five mults. To change jobs, the operator stands at an operating station and enters the number of desired mults, the desired individual mult widths, the material thickness, the desired percentage of horizontal gap between cooperating upper and lower knives, the desired relative vertical knife position, and the desired offset distance from centerline into a human-to-machine (HMI) interface coupled to the programmable logic controller. The slitting machine itself then sets up the machine automatically.

The programmable logic controller is preferably part of a closed-loop feedback control system which receives one or more signals from sensors monitoring the position or movement of the knives and which reacts to the sensed position or movement of the knives to properly position the knives on the upper and lower arbors.

As a result of the various embodiments of this invention, a slitting machine is easily and efficiently set up and reconfigured by an operator through the HMI interface, programmable logic controller and the upper and lower knife assembly positioning devices for slitting mults of various sizes without significant machine downtime and labor-intensive procedures. Furthermore, the machine is readily adjustable for slitting metal sheets of differing thicknesses by conveniently adjusting the upper frame relative to the lower frame.

The above and other objects and advantages of the present invention shall be made apparent from the accompanying drawings and the description thereof.

### BRIEF DESCRIPTION OF THE DRAWINGS

The objectives and features of the invention will become more readily apparent from the following detailed description taken in conjunction with the accompanying drawings in which:

FIG. 1A Illustrates a side elevational view and

FIG. 1B illustrates a front elevational view of a slitting machine according to one embodiment of the present invention;

FIG. 2A is a view similar to FIG. 1A and

FIG. 2B is a view similar to FIG. 1B illustrating a slitting machine according to a second embodiment of the present invention;

FIG. 3A is a view similar to FIG. 1A and

FIG. 3B is a view similar to FIG. 1B illustrating a slitting machine according to a third embodiment of the present invention;

FIG. 4 illustrates a side elevational view in partial cross-section of back-up rolls and arbors used in a slitting machine according to a fourth embodiment of the present invention;

FIG. 5A and FIG. 5B illustrate a side elevational view,

FIG. 5C illustrates a top plan view in partial cross-section and

FIG. 5D illustrates a front elevational view of a slitting machine according to a fifth embodiment of the present invention;

FIG. 5E illustrates a front elevational view and

FIG. 5F illustrates a side elevational view of the rotary knives and split retaining collars used in the slitting machine of FIG. 5A;

FIG. 6A illustrates a front elevational sectional view and

FIG. 6B illustrates a side elevational view in partial cross-section of rotary knives and arbors used in a slitting machine according to a sixth embodiment of the present invention;

FIG. 6C illustrates a side elevational view in partial cross section of the knives and arbors used in the slitting machine of FIG. 6A;

FIG. 7C illustrates a a top plan view, FIG. 7A illustrates a side elevational view and FIG. 7B illustrates a side elevational view in partial cross-section view of a slitting machine according to a seventh embodiment of the present invention;

FIG. 8B illustrates a knife detail view, FIG. 8A illustrates a side elevational view in partial cross-section of a slitting machine according to an eighth embodiment of the present invention;

FIG. 9 is a side elevational view in partial cross section of a slitting machine according to a ninth embodiment of the present invention;

FIG. 10A is a side elevational view and

FIG. 10B is a front elevational view of a slitting machine according to a tenth embodiment of the present invention;

FIG. 11A Is a side elevational view and

FIG. 11B is a front elevational view of a slitting machine according to a eleventh embodiment of the present invention;

FIG. 12A Is a side elevational view In partial cross-section and FIG. 12C is a front elevational view of an expandable arbor in accordance with one aspect of the present invention and

FIG. 12B is a side elevational view in partial cross-section; and

FIG. 13 is a front elevational view of an expandable arbor in accordance with another aspect of the present invention.

### DETAILED DESCRIPTION OF THE PREFERRED EMBODIMENT

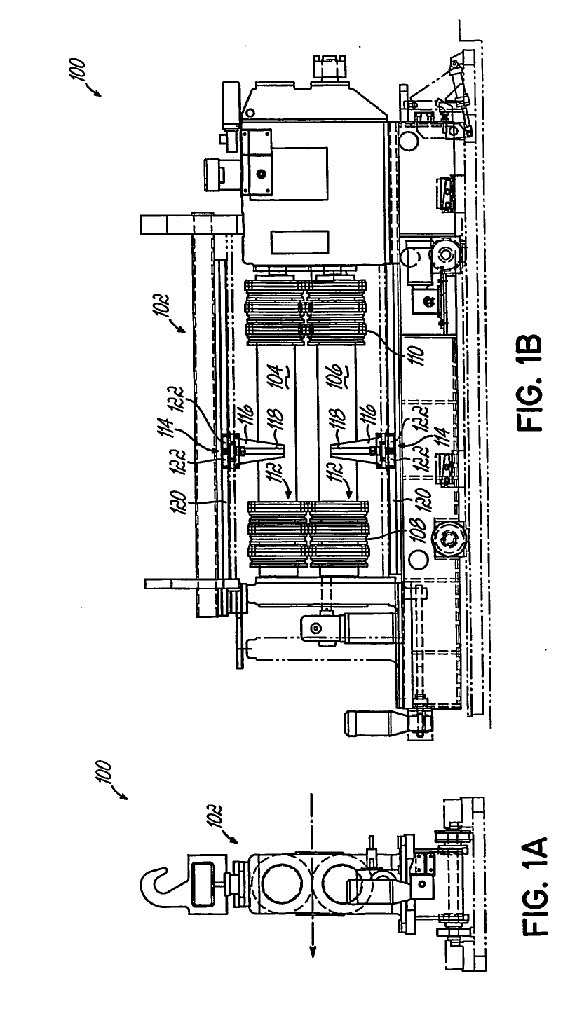

Referring to FIGS. 1A and 1B, a CNC slitting machine 100 according to a first embodiment of the present invention is used for shearing metal sheet, such as sheet steel, into multiple segments or mults of a desired width along slits. The metal sheet is normally provided from a mill or other supplier of mill products In a coil. The coil is supported on a spool. The metal sheet is withdrawn from the coil and fed into the machine 100. Typically, the metal sheet passes through a straightening machine to remove the coil set. The sheet alternatively may be fed into the machine 100 in individual sections, preferably with the assistance of a skewed roller table (not shown) or the like.

In accordance with one embodiment of the present invention, as shown in FIGS. 1A and 1B, slitting machine 100 includes a frame 102 and upper and lower arbors 104, 106, respectively, mounted therein for rotation. The arbors 104, 106 are supported in the frame 102 by conventional bearings and are coupled In a conventional manner to a motor which provides rotational movement to the upper and lower arbors 104, 106. The upper and lower arbors 104, 106 are rotated in opposite counter-rotating directions for pulling and slitting the metal sheet passing therebetween.

A number of knife hubs 108 are supported for movement and subsequent fixed positioning along the upper and lower arbors 104,106 with each knife hub 108 supporting a knife 110 to form multiple knife assemblies 112. The knife assemblies 112 are supported and fixed in cooperating pairs at spaced positions along the upper and lower arbors 104, 106 to cut, shear or otherwise slit the metal sheet as it passes between the knives 110 on the upper and lower arbors 104, 106. A total of twelve knife assemblies 112 (six pair) are shown in FIG. 1 B for producing five strips or mults. Although, it should be readily understood that the exact number of knife assemblies 112 is dependent upon the desired width and configuration of the mults and the metal sheet being slit.

Further referring to FIG. 1B, a pair of upper and lower knife assembly positioning devices 114, one corresponding to each arbor 104,106, are supported by the frame 102 and are operable to move along the length of the frame 102 in response to a drive mechanism associated with each respective knife assembly positioning device 114 as described in detail below. Each upper and lower knife assembly positioning device 114 comprises a pair of oppositely disposed, pivotally or sliding supported jaws or clamping members 116 that are adapted to grasp and position each of the knife assemblies 112 at spaced positions along the upper and lower arbors 104, 106. Each of the pair of jaws 116 in the respective knife assembly positioning devices 114 is positioned fore or aft of a knife assembly 112 and includes a finger 118 that is operable to grasp and release a fore or aft portion of the knife assemblies 112. Each upper and lower knife positioning device 114 includes a hydraulic or pneumatic piston/cylinder mechanism to control fore and aft spacing of the jaws 116 to grasp and release the knife assemblies 112. The jaws 116 of each knife assembly positioning device 114 grasp a knife assembly 112 prior to movement of the knife assembly positioning device 114 along the length of frame 102. When the knife assembly positioning devices 114 move respective knife assemblies 112 to proper positions along the upper and lower arbors 104, 106, the Jaws 116 open In the fore and aft direction to release the knife assemblies 112 and the knife assembly positioning devices 114 then return to position the next pair of knife assemblies 112 along the upper and lower arbors 104, 106.

The frame 102 supports upper and lower pairs of rails 120 which extend lengthwise on slitting machine 100 for supporting the upper and lower knife assembly positioning devices 114. Linear bearing blocks 122 are mounted to each of the knife assembly positioning devices 114 so that the linear bearing blocks 122 capture one of the upper and lower pairs of rails 120. Other rail structures such as racks, and pinions associated with each knife assembly positioning device 114 are possible as well.

Various drive mechanisms are contemplated for moving the knife assembly positioning devices 114 along the pairs of rails 120 to position the knife assemblies 112 at predetermined positions along the upper and lower arbors 104, 106. For example, the drive mechanisms may comprise hydraulic or pneumatic cylinders operatively connected either permanently or temporarily to each knife assembly positioning device 114, stepper motors, servo motors, DC motors, AC motors, pneumatic motors, hydraulic motors, linear induction motors or any other type of drive motor associated with each knife assembly positioning device 114, upper and lower motorized ball screws extending lengthwise along the slitting machine 100 and a stationary ball nut associated with each knife assembly positioning device 114, or upper and lower stationary ball screws extending lengthwise along the slitting machine and motorized ball nuts associated with each knife assembly positioning device 114. The present invention contemplates any type of drive mechanism that Is capable of moving each of the knife assembly positioning devices 114 along a linear path to position the knife assemblies 112 at predetermined positions along the upper and lower arbors 104, 106.

Further referring to FIG. 1B, each drive mechanism for moving the upper and lower knife assembly positioning devices 114 is electrically coupled to a programmable logic controller (not shown). The programmable logic controller is coupled to a human-to-machine (HMI) interface (not shown), such as a touch screen or the like, that receives data inputs from a user. The programmable logic controller is also coupled to user inputs, such as user actuatable buttons, so that the controller receives these user inputs as well to control operation of the CNC slitting machine 100.

Each drive mechanism receives instructions from the programmable logic controller according to inputs entered by the operator through the HMI Interface and, upon actuation, the respective drive mechanisms move the respective knife assembly positioning devices 114 to position the knife assemblies 112 at the appropriate positions along the upper and lower arbors 104, 106. The user inputs to the HMI interface may include the number of desired mults, the desired width of each mult, the material thickness of the metal sheet, the desired percentage of horizontal gap between cooperating upper and lower knives 110, the desired relative vertical distance of the upper and lower knives 110 and the desired offset distance from centerline, although other Inputs are possible as well without departing from the spirit and scope of the present invention. This information is then processed by the programmable logic controller which sends appropriate Instructions to each of the drive mechanisms associated with the knife assembly positioning devices 114 to position the knife assemblies 112 along the upper and lower arbors 104, 106 as appropriate.

A pair of upper and lower linear encoders (not shown) are associated with the upper and lower knife assembly positioning devices 114 to provide inputs to the programmable logic controller to indicate the position of each knife assembly positioning device 114 relative to a fixed reference point, so that the position of each knife assembly positioning device 114 relative to the length of respective upper and lower arbors 104, 106 can be determined. Each upper and lower linear encoder includes an elongated scale (not shown) that is supported by the frame 102 and scanning units (not shown) that are each mounted to one of the knife assembly position devices 114. The scanning units (not shown) are electrically coupled to the controller (not shown) and are operable to read a scale (not shown) housed within each linear encoder (not shown) and provide scale data to the programmable logic controller (not shown) so that the position of each knife assembly positioning device 114 is monitored and controlled by the controller in a closed-loop feedback control. A suitable linear encoder for use In the slitting machine 100 of the present invention is commercially available from Heidenhain Corporation of Schaumburg, Ill., although other linear encoders and other position detecting systems are possible as well.

Once the knife assemblies 112 have been appropriately positioned along the upper and lower arbors 104, 106 by the knife assembly positioning devices 114, the arbors 104, 106 expand with hydraulic power to secure the knife assemblies 112 in place as will be appreciated by those of ordinary skill in the art. Other types of arbor designs are contemplated as well to secure the knife assemblies 112 in place as described in greater detail below.

The relative vertical positioning of the upper and lower rotary knives 110 is adjustable through an eccentric (not shown) associated with the slitting machine 110 to accommodate metal sheets of different thicknesses passing between the knife assemblies 112 for slitting. The eccentric (not shown) allows the spacing between the upper and lower arbors 104, 106 to be adjusted to control the relative vertical positioning of the upper and lower knife assemblies 112. Movement of the eccentric (not shown) may be either manually controlled or automatically controlled through a user input to the HMI interface (not shown) that causes the programmable logic controller (not shown) to send an appropriate instruction to a drive mechanism (not shown) associated with the eccentric (not shown).

As shown on the left side in FIG. 1B, a portion of the frame, i.e., the left side of the frame 102, slides away to permit knife assemblies 112 to be added or removed from the upper and lower arbors 104,106. The appropriate knife assembly 112 can be conveniently and efficiently moved toward the end of the upper or lower arbors 104, 106 for repair, replacement or servicing, and/or additional knife assemblies 112 can be added to the upper or lower arbors 104, 106 as required for a particular slitting operation.

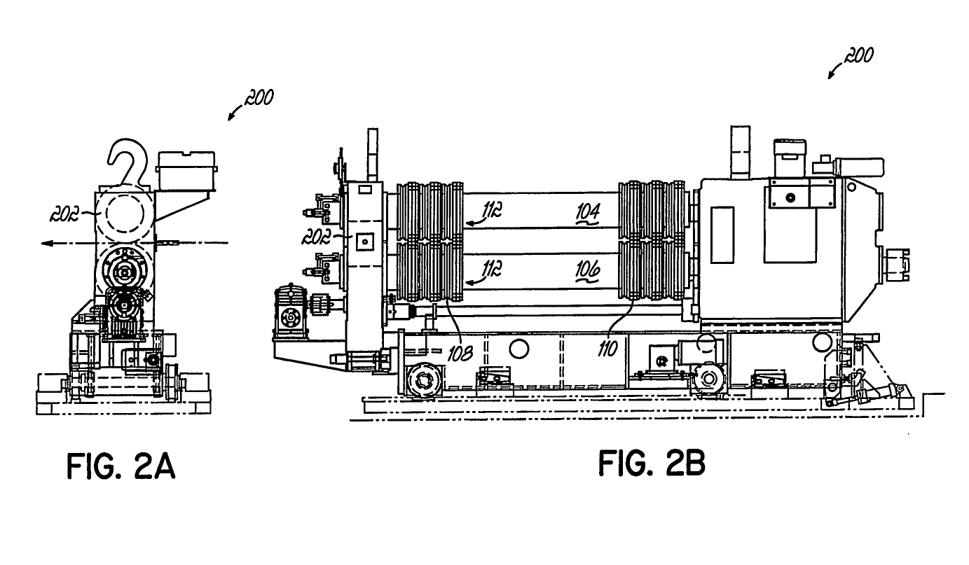

Referring now to FIGS. 2A and 2B, a CNC slitting machine 200 in accordance with a second embodiment of the present invention is shown, where like numerals represent like parts to the CNC slitting machine 100 of FIG. 1. In this embodiment, a portion of the frame, i.e., the left side of the frame 202 as shown in FIG. 2B, pivots or swings out to permit knife assemblies 112 to be added or removed from the upper and lower arbors 104, 106 In similar fashion to FIG. 1. The positioning of knife assemblies 112 Is the same as found in CNC slitting machine 100.

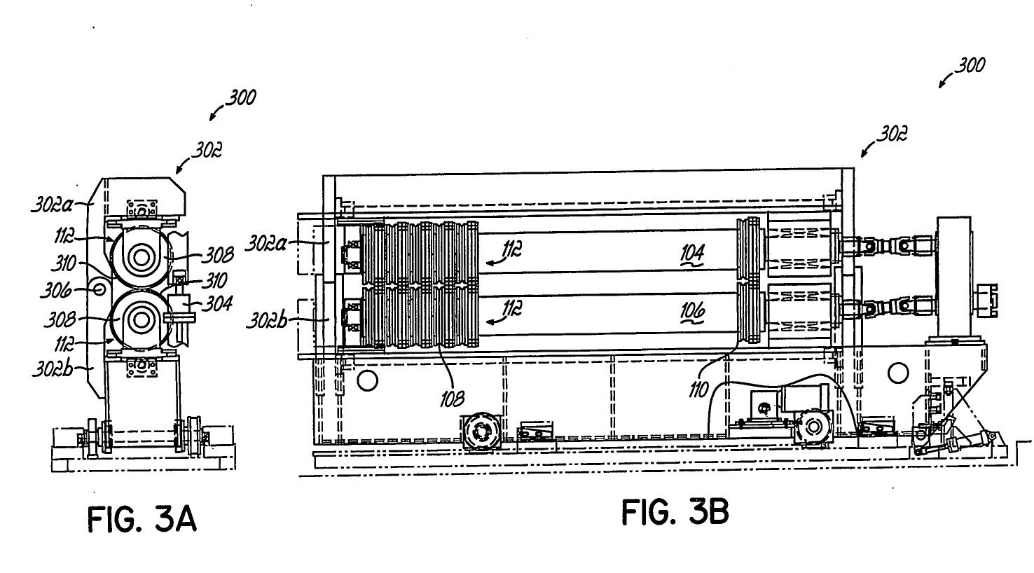

Referring now to FIGS. 3A and 3B, a CNC slitting machine 300 in accordance with a third embodiment of the present invention is shown, where like numerals represent like parts to the CNC slitting machine 100 of FIG. 1. In this embodiment, the frame 302 comprises an upper frame 302a movably coupled at spaced ends thereof to a lower frame 302b. The upper and lower frames 302a, 302b of the machine 300 include the upper and lower arbors 104,106, respectively, mounted therein for rotation. A pair of jack screws 304 are positioned between spaced opposite ends of the upper and lower frames 302a, 302b of the slitting machine 300. The Jack screws 304 are positioned between the upper and lower frames 302a, 302b proximate a front of the machine 300. The upper and lower frames 302a, 302b are pivotally coupled together around a pivot shaft 306 proximate the back of the machine 300. The lower frame 302b Is stationary while the upper frame 302a is capable of pivotal movement relative to the lower frame 302b about the pivot shaft 306. A pair of die springs may be connected between the upper frame 302a and the lower frame 302b on respective opposite sides of the slitting machine 100 and close to the jack screws 304 to eliminate clearances between the upper and lower frames 302a, 302b at their connection points. A jack screw motor (not shown) is mounted to provide a rotational Input to one of the jack screws 304 and to a jack screw transfer (not shown) shaft that couples the two jack screws 304 together. Coupling sleeves (not shown) are mounted on each of the spaced ends of the transfer shaft for joining the shaft to the respective Jack screw 304.

In operation, the jack screw motor (not shown) provides a rotational input to the adjacent jack screw 304 and to the opposite jack screw 304 through the transfer shaft (not shown). The jack screw motor (not shown) is electrically coupled to the programmable logic controller (not shown) and receives instructions from the controller according to inputs entered by the operator through the HMI interface (not shown). Rotation of the motor (not shown) simultaneously raises or lowers the jack screws 304 for pivotally moving the upper frame 302a relative to the stationary lower frame 302b about the pivot shaft 306. As a result, the spacing between the upper and lower arbors 104, 106 is adjustable by rotation of the jack screw motor that causes extension or retraction of the jack screws 304. The movement of the upper and lower frames 302a, 302b and the associated upper and lower arbors 104, 106 relative to each other controls the relative vertical positioning of the rotary knives 110 to accommodate metal sheet of different thicknesses passing between the knife assembles 112 for slitting. The jack screw motor coupled to each of the jack screws 304 allows for more precise adjustment of both jack screws 304 and the movement of the upper arbor 104 relative to the lower arbor 106 in a generally parallel orientation throughout the movement. As a result, the vertical spacing between the knife assemblies 112 on the upper arbor 104 relative to the knife assemblies 112 on the lower arbor 106 is consistent and does not vary dependent upon the lateral position of the respective knife assemblies 112. It will be appreciated that the jack screw motor (not shown) could be replaced with a hand wheel (not shown) or any other suitable device that is capable of moving the jack screws 304 as desired. Moreover, it will be appreciated that the jack screws 304 can be replaced with any other type of motor capable of moving the upper frame 302a relative to the lower frame 302b about the pivot shaft 306. The positioning of knife assemblies 112 Is the same as found in CNC slitting machine 100.

Precise alignment of the upper frame 302a relative to the lower frame 302b is provided by an alignment block (not shown) fixed to the upper frame 302a being captured within a levis fixed (not shown) to the lower frame 302b. The tolerances of the alignment block and clevis (not shown) are selected to assure proper registration of the upper and lower frames 302a, 302b relative to each other. The engagement surfaces of the alignment block and/or the clevis (not shown) may be hardened with a suitable material to reduce wear of the alignment components through repeated movement of the upper frame 302a relative to the fixed lower frame 302b.

In each of the slitting machines 100, 200 and 300 of FIGS. 1A-1B, 2A-2B and 3A-3B, respectively, the arbors 104, 106 bear the entire separating load imparted on the knive hubs 108 and knives 110 during a slitting operation. This may be disadvantageous, in that the arbors 104, 106 must have significant strength so as to sustain that separating load. This tends to make the arbors 104, 106 heavy and require a large diameter.

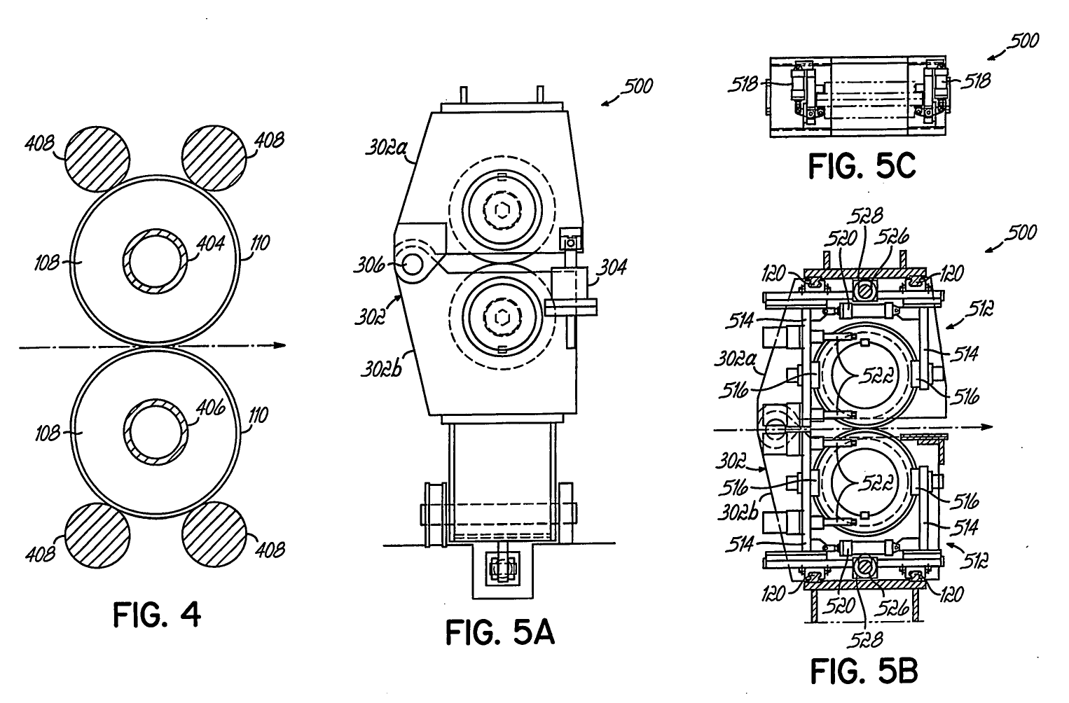

In accordance with a fourth embodiment of the present invention, as shown in FIG. 4, the expandable arbors 104, 106 are provided with backup rolls 408 that engage the circumference of the knives 110 supported In the hubs 108 to counteract the separating forces Imparted on the knives 110 during a slitting operation and thereby inhibit deflection or separation of the hollow arbors 404, 406. The backup rolls 408 may be manufactured of hardened steel and extend the length of the machine frame. A pair of backup rolls 408 are provided to contact each of the upper and lower knives 110 supported on the arbors 404, 406. The backup rolls 408 are idler rolls that rotate in a counter rotational direction to their respective upper and lower knives 110 due to their contact with the circumference of the knives 110.

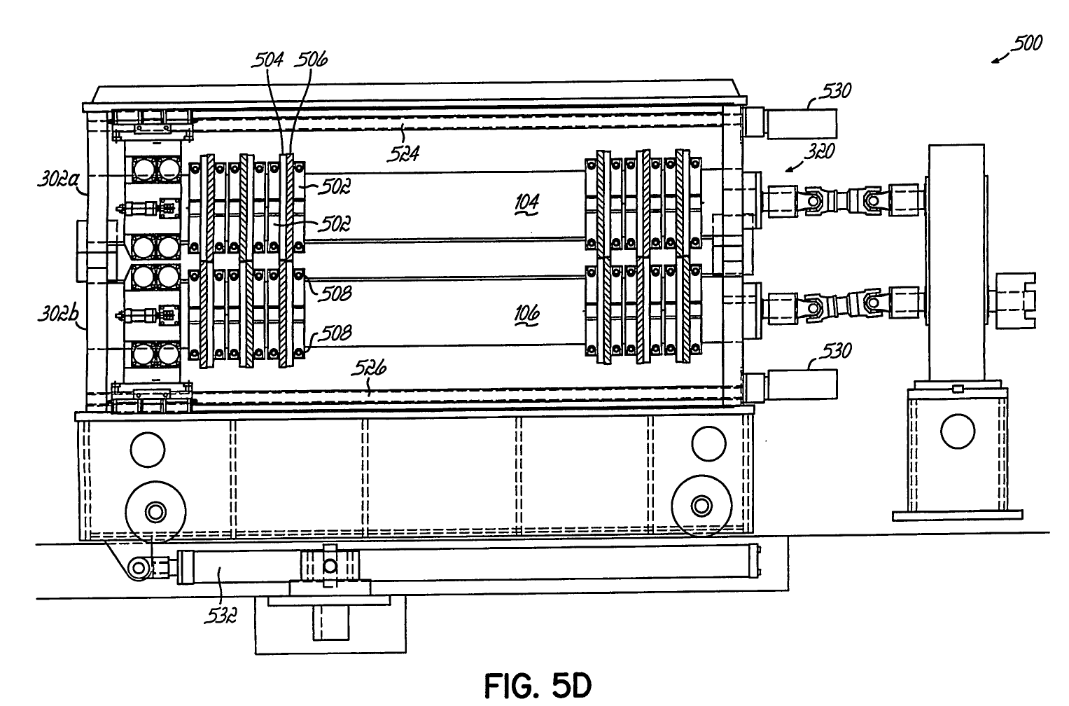

Referring now to FIGS. 5A-5F, a CNC slitting machine 500 in accordance with a fifth embodiment of the present invention is shown, where like numerals represent like parts to the CNC slitting machines 100 and 300 of FIGS. 1A-1B and 3A-3B, respectively. In this embodiment, each knife hub comprises a pair of split collars 502 (FIGS. 5E and 5F) that are disposed outboard of the knife 504 and stripper ring 506. A pair of screws 508 are provided to join the pair of split collars 502 of each knife assembly 510.

As shown in FIG. 5B, a pair of upper and lower knife assembly positioning devices 512, one corresponding to each arbor 104, 106, are supported by the upper and lower frames 302a, 302b, respectively, and are operable to move along the length of the upper and lower frames 302a, 302b in response to a drive mechanism (not shown) associated with each respective knife assembly positioning device 512 as described in detail below. Each upper and lower knife assembly positioning device 512 comprises a pair of oppositely disposed, pivotally supported Jaws or clamping members 514 that are adapted to grasp and position each of the knife assemblies 510 at spaced positions along the upper and lower arbors 104, 106. Each of the pair of jaws 514 in the respective knife assembly positioning devices 512 is positioned fore or aft of a knife assembly 510 and includes a pair of side-by-side contacts 516 that are operable to grasp and release a fore or aft portion of the knife assemblies 510. Each upper and lower knife positioning device 512 includes a pair of hydraulic or pneumatic piston/cylinder mechanisms 518 to control side-by-side spacing of the jaws 514 to grasp and release the knife assemblies 510. Each upper and lower knife positioning device 512 further includes a hydraulic or pneumatic piston/cylinder mechanism 520 to control fore and aft spacing of the jaws 514.

Further referring to FIG. 5B, each knife assembly positioning device 512 includes pairs of upper and lower tightening devices 522 (four (4) total) mounted on the fore jaw 514 that are operable to register with and tighten the upper and lower screws 508 provided on the pair of split collars 502 associated with each knife assembly 510. The contacts 516 of each knife assembly positioning device 512 grasp a knife assembly 510 prior to movement of the knife assembly positioning device 512 along the length of frame 302. When the knife assembly positioning devices 512 move respective knife assemblies 510 to proper positions along the upper and lower arbors 104, 106, the tightening devices 522 are operated to tighten the split collars 502 about the upper and lower arbors 104, 106 to secure the knife assemblies 510 at their proper positions. Thereafter, the jaws 514 open in both the fore and aft and the side-by-side directions to disengage the tightening devices 522 from the screws 508 and to release the contacts 516 from the knife assemblies 510. The knife assembly positioning devices 512 then return to position and tighten the next pair of knife assemblies 510 along the upper and lower arbors 104, 106.

Each of the knife assembly positioning devices 512 Is operatively coupled to either a rotatable upper threaded shaft 524 or a rotatable lower threaded shaft 526. The respective rotatable threaded shafts 524, 526 pass through a stationary ball nut 528 in each of the knife assembly positioning devices 512. Each threaded shaft 524, 526 Is connected to a positioning motor 530 which is electrically coupled to the programmable logic controller. The positioning motor 530 may be a servo motor, stepper motor, DC motor, AC vector motor, pneumatic motor, hydraulic motor, linear induction motor or any other type of drive motor.

Each positioning motor 530 receives instructions from the programmable logic controller (not shown) according to inputs entered by the operator through the HMI interface (not shown) and, upon actuation, the respective positioning motors 530 rotate the upper and lower threaded shafts 524, 526. Rotation in the appropriate direction of the upper and lower threaded shafts 524, 526 that are threadably coupled to the fixed or stationary ball nuts 528 associated with each knife assembly positioning device 512 moves the knife assembly positioning devices 512 along the length of the upper and lower frames 302a, 302b to locate the knife assemblies 510 at their appropriate positions.

Various alternative drive mechanisms are contemplated for moving the knife assembly positioning devices 512 along the pairs of rails 120 to position the knife assemblies 510 at predetermined positions along the upper and lower arbors 104, 106. For example, the drive mechanisms may comprise hydraulic or pneumatic cylinders operatively connected either permanently or temporarily to each knife positioning device 512, stepper motors, servo motors, DC motors, AC motors, pneumatic motors, hydraulic motors, linear induction motors or any other type of drive motor associated with each knife assembly positioning device 512, or upper and lower stationary ball screws extending lengthwise along the slitting machine 500 and motorized ball nuts associated with each knife assembly positioning device 512. The present invention contemplates any type of drive mechanism that is capable of moving each of the knife assembly positioning devices 512 along a linear path to position the knife assemblies 510 at predetermined positions along the upper and lower arbors 104, 106.

As shown on the left side of FIG. 5D, the frame 302 is operable to be traversed through extension of a hydraulic piston/cylinder mechanism 532. This permits knife assemblies 510 to added or removed from the upper and lower arbors 104, 106. The appropriate knife assembly 510 can be conveniently and efficiently moved toward the end of the upper and lower arbors 104, 106 for repair, replacement or servicing, and/or additional knife assemblies 510 can be added to the upper or lower arbors 104, 106 as required for a particular slitting operation.

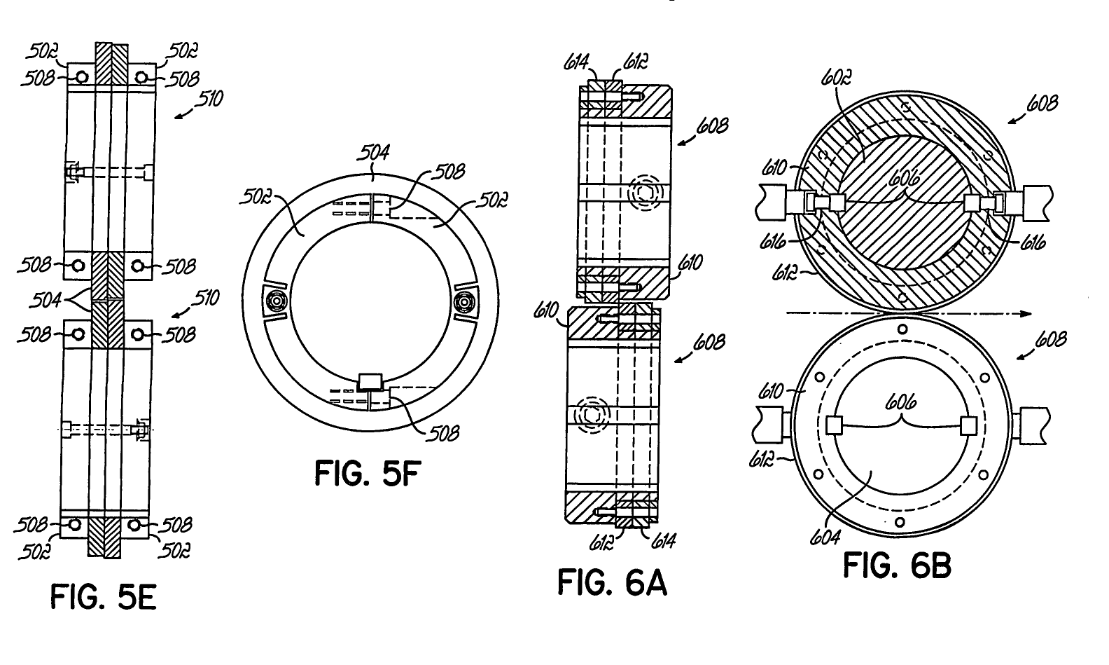

Referring now to FIGS. 6A-6C, a CNC slitting machine 600 in accordance with a sixth embodiment of the present invention Is shown. In this embodiment, each of the upper and lower arbors 602, 604 includes a pair of oppositely disposed slots 606 extending lengthwise of the arbors 602, 604, and each knife assembly 608 Includes a knife hub 610, a knife 612, a stripper ring 614 and a pair of oppositely disposed set screws 616 that engage the upper or lower arbors 602, 604 within the respective pair of slots 606.

As shown in FIG. 6D, a pair of upper and lower knife assembly positioning devices 618, one corresponding to each arbor 602, 604, are supported by the frame 620, and are operable to move along the length of the frame 620 in response to a drive mechanism (not shown) associated with each respective knife assembly positioning device 618 as described in detail above In connection with the drive mechanisms associated with knife assembly positioning devices 512 of FIGS. 5A-5F. Each upper and lower knife assembly positioning device 618 comprises a pair of oppositely disposed, pivotally or sliding supported jaws or clamping members 622 that are positioned fore or aft of a knife assembly 608. Each upper and lower knife positioning device 618 includes a hydraulic or pneumatic piston/cylinder mechanism 624 to control fore and aft spacing of the jaws 622.

Further referring to FIG. 6C, each knife assembly positioning device 618 includes a pair of fore and aft tightening devices 626 (two (2) total) mounted respectively on the fore and aft jaws 622 that are operable to register with and tighten the fore and aft set screws 616 provided on each knife assembly 608. The tightening devices 626 of each knife assembly positioning device 618 are used to engage and carry the knife assemblies 608 along the length of the upper and lower arbors 602, 604 during movement of the knife assembly positioning devices 618 along the length of frame 620. When the knife assembly positioning devices 618 move respective knife assemblies 608 to proper positions along the upper and lower arbors 602, 604, the tightening devices 626 are operated to tighten the set screws 616 to secure the knife assemblies 608 at their proper positions. Thereafter, the jaws 622 open in the fore and aft direction to disengage the tightening devices 626 from the set screws 616. The knife assembly positioning devices 618 then return to position and tighten the next pair of knife assemblies 608 along the upper and lower arbors 602, 604.

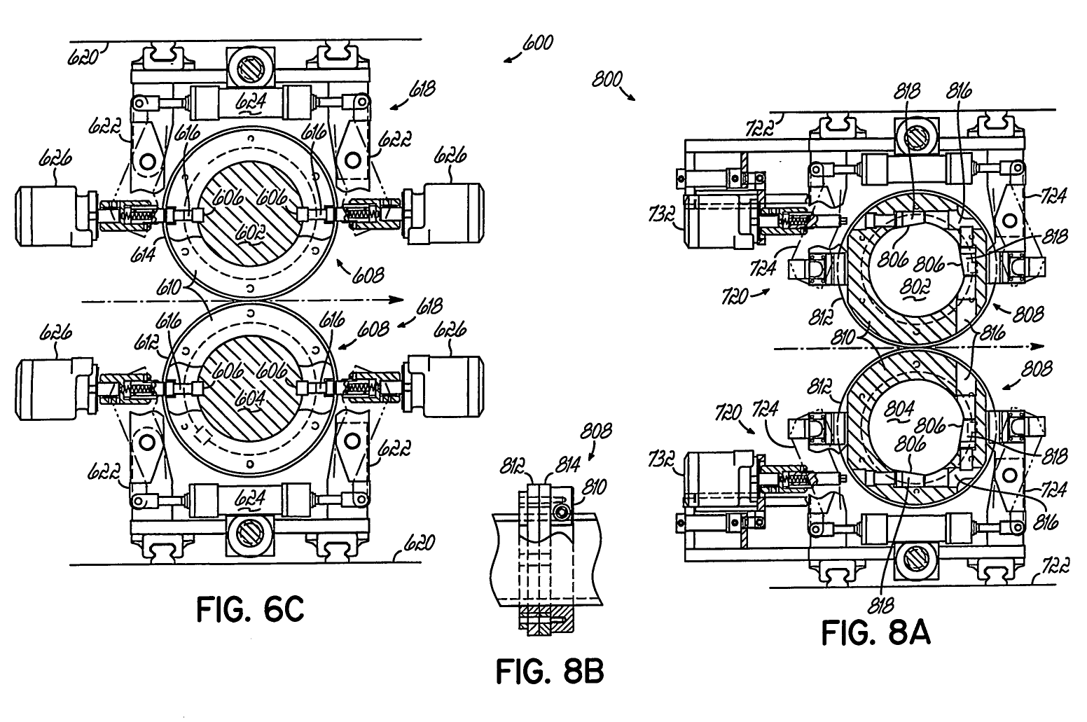

Referring now to FIGS. 7A-7C, a CNC slitting machine 700 in accordance with a seventh embodiment of the present Invention Is shown. In this embodiment, each of the upper and lower arbors 702, 704 includes a pair of oppositely disposed planar surfaces 706 extending lengthwise of the arbors 702, 704, and each knife assembly 708 includes a knife hub 710, a knife 712 and a stripper ring 714. Each knife hub 710 includes a pair of partially threaded bores 716 communicating between respective planar surfaces 706 of the upper or lower arbors 702, 704 and an exterior surface of the knife hub 710. Wedges 717 are positioned within the bores 716 for frictional engagement with the planar surfaces 706 of the upper and lower arbors 702, 704. Threaded studs 718 are positioned within the bores 716 outboard of the wedges 717 to urge the wedges 717 Into engagement with the upper and lower arbors 702, 704.

As shown in FIG. 7B, a pair of upper and lower knife assembly positioning devices 720, one corresponding to each arbor 702, 704, are supported by the frame 722, and are operable to move along the length of the frame 722 in response to a drive mechanism associated with each respective knife assembly positioning device 720 as described In detail above in connection with the drive mechanisms associated with knife assembly positioning devices 512 of FIGS. 5A-5F.

Each upper and lower knife assembly positioning device 720 comprises a pair of oppositely disposed, pivotally or sliding supported jaws or clamping members 724 that are adapted to grasp and position each of the knife assemblies 708 at spaced positions along the upper and lower arbors 702, 704. Each of the pair of jaws 724 in the respective knife assembly positioning devices 720 Is positioned fore or aft of a knife assembly 708 and includes a pair of side-by-side contacts 726 that are operable to grasp and release a fore or aft portion of the knife assemblies 708. Each upper and lower knife positioning device 720 includes a pair of hydraulic or pneumatic piston/cylinder mechanisms 728 to control side-by-side spacing of the Jaws 724 to grasp and release the knife assemblies 708. Each upper and lower knife positioning device 720 further includes a hydraulic or pneumatic piston/cylinder mechanism 730 to control fore and aft spacing of the jaws 724.

Further referring to FIG. 7B, each knife assembly positioning device 720 includes a pair of fore and aft tightening devices 732 (two (2) total) mounted respectively on the fore and aft jaws 724 that are operable to register with and tighten the fore and aft studs 718 provided in each knife assembly 708. The jaws 724 of each knife assembly positioning device 720 grasp a knife assembly 708 prior to movement of the knife assembly positioning device 720 along the length of frame 722. When the knife assembly positioning devices 720 move respective knife assemblies 708 to proper positions along the upper and lower arbors 702, 704, the tightening devices 732 are operated to rotate the threaded studs 718 to thereby urge the wedges 717 into engagement-with the planar surfaces 706 on the upper and lower arbors 702, 704 to secure the knife assemblies 708 at their proper positions. Thereafter, the jaws 724 open in both the fore and aft and the side-by-side directions to disengage the tightening devices 732 from the threaded studs 718 and to release the contacts 726 from the knife assemblies 708. The knife assembly positioning devices 720 then return to position and tighten the next pair of knife assemblies 708 along the upper and lower arbors 702, 704.

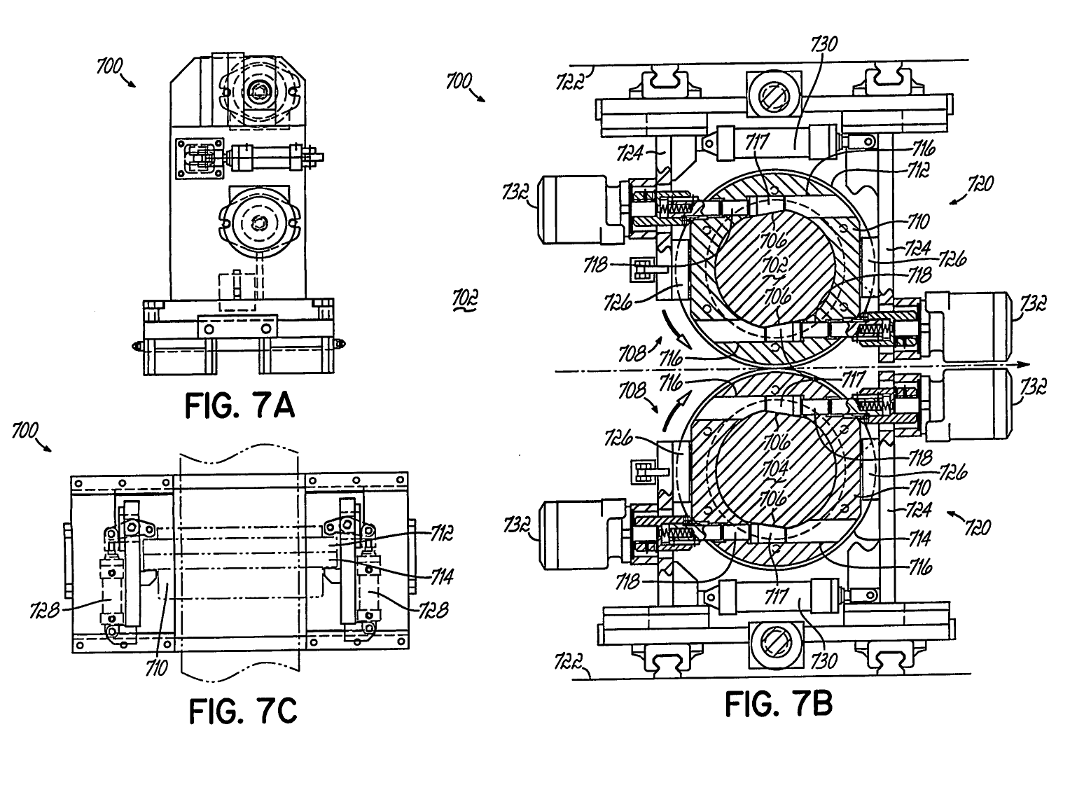

Referring now to FIGS. 8A-8C, a CNC slitting machine 800 In accordance with an eighth embodiment of the present invention is shown, where like numerals represent like parts to the CNC slitting machine 700 of FIGS. 7A-7C. In this embodiment, only one tightening device 732 is provided on the fore jaw 724 of each knife assembly positioning device 720. Also, in this embodiment, each of the upper and lower arbors 802, 804 includes a pair of planar surfaces 806 extending lengthwise of the arbors 802, 804 that are oriented generally 900 relative to each other. Each knife assembly 808 includes a knife hub 810, a knife 812 and a stripper ring 814. In this embodiment, each knife hub 810 includes a pair of partially threaded bores 816 communicating between respective planar surfaces 806 of the upper or lower arbors 802, 804 and an exterior surface of the knife hub 810. The partially threaded bores 816 of each knife assembly 808 are oriented generally 900 relative to each other. Wedges 717 are positioned within the bores 816 for frictional engagement with the planar surfaces 806 of the upper and lower arbors 802, 804. Threaded studs 818 are positioned within the bores 816 outboard of the wedges 717 to urge the wedges 717 into engagement with the upper and lower arbors 802,804 to position the knife assemblies 808 along the upper and lower arbors 802, 804 in similar fashion to the knife assemblies 708 described In detail above in connection with the CNC slitting machine 700 of FIGS. 7A-7C.

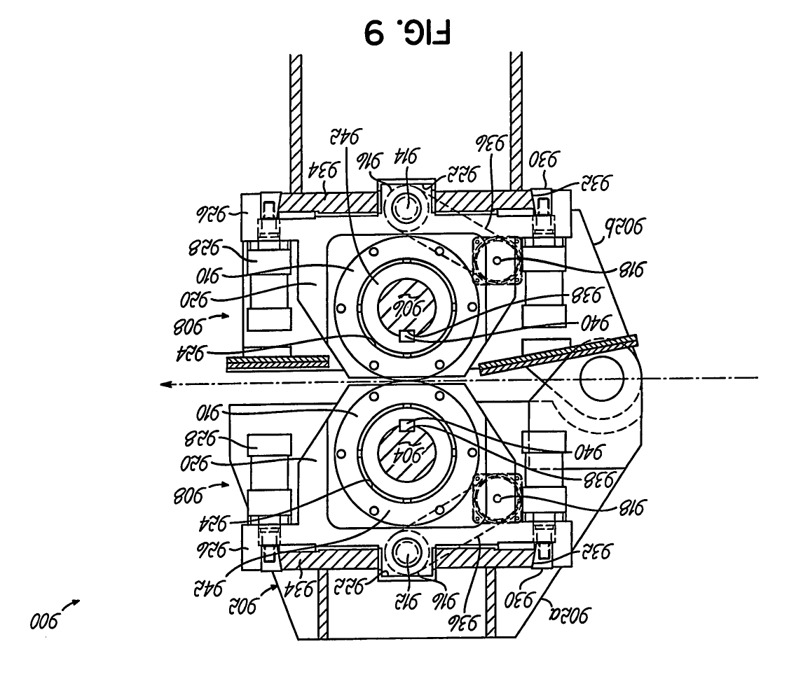

Referring now to FIG. 9, a CNC slitting machine 900 In accordance with a ninth embodiment of the present invention is shown. Slitting machine 900 includes a frame 902 and upper and lower arbors 904, 906, respectively, mounted therein for rotation. The arbors 904, 906 are supported in the frame 902 by conventional bearings and are coupled in a conventional manner to a motor (not shown) which provides rotational movement to the upper and lower arbors 904, 906. The upper and lower arbors 904, 906 are rotated in opposite counter-rotating directions for pulling and slitting the metal sheet passing therebetween.

A number of knife holder assemblies 908 are supported for movement along the upper and lower arbors 904, 906. The knife holder assemblies 908 are supported in cooperating pairs at spaced positions along the upper and lower arbors 904, 906 in the upper and lower frames 902a, 902b, respectively. The metal sheet to be slit passes between the knife holder assemblies 908 on the upper arbor 904 and the knife holder assemblies 908 on the lower arbor 906. Each upper knife holder assembly 908 Includes a rotary knife 910 which cooperates with the rotary knife 910 in the corresponding lower knife holder assembly 908 of each cooperating pair to cut, shear or otherwise slit the metal sheet A total of twelve knife holder assemblies 908 (six pair) may be provided (not shown) for producing five strips or mults. Although, it should be readily understood that the exact number of knife holder assemblies 908 Is dependent upon the desired width and configuration of the mults and the metal sheet being slit.

Each of the knife holder assemblies 908 is not only supported for movement along the respective upper and lower arbors 904, 906, but is also operatively coupled to either a fixed upper threaded shaft 912 or a fixed lower threaded shaft 914. The respective fixed or stationary threaded shafts 912, 914 pass through a ball nut 916 in each of the knife holder assemblies 908. Each ball nut 916 is connected to a positioning motor 918 which is electrically coupled to the programmable logic controller (not shown) described in detail above in connection with the CNC slitting machine 100 of FIGS. 1A-1 B. The upper and lower threaded shafts 912, 914, ball nuts 916, positioning motors 918, programmable logic controller and associated components contribute to form a knife holder position adjustment system that moves the Individual knife holder assemblies 908 along the respective upper and lower arbors 904, 906 for proper, efficient and accurate positioning prior to slitting the metal sheet as described in detail below.

The knife holder assemblies 908 are supported in cooperating pairs along the upper and lower arbors 904, 906 such that one knife holder assembly 908 of each pair is positioned along the upper arbor 904 and the complimentary knife holder assembly 908 of each pair is positioned along the lower arbor 906. The knife holder assemblies 908 are generally Identical with the exception of their orientation in the slitting machine 900; therefore, a knife holder assembly 908 positioned along the upper arbor 904 will be described. It should be readily understood that the same description applies to each of the other knife holder assemblies 908 positioned along the upper arbor 904 as well as those positioned along the lower arbor 906 in a reoriented position.

Further referring to FIG. 9, each knife holder assembly 908 includes a retainer block 920 with an upper smaller hole 922 and a lower larger hole 924 passing between the front and back faces of the retainer block 920. The retainer block 920 also includes a pair of anchor flanges 926 spaced on the lateral sides of the retainer block 920 and positioned with an exposed face similarly oriented in the direction of the smaller hole 922.

A hydraulic piston/cylinder mechanism 928 is mounted to each of the anchor flanges 926. Each piston of the hydraulic piston/cylinder mechanisms 928 terminates in a wedge 930 that cooperates with a tapered edge 932 formed on opposite sides of upper and lower wear plates 934 that extend lengthwise of the machine 900 to slidably support the knife holder assemblies 908 for movement along the length of the upper and lower frames 902a, 902b. Each anchor flange 926 further supports a pair of stationary wedges 930 outboard of the respective hydraulically actuated wedge 930 associated with each anchor flange 926. The pair of stationary wedges 930 associated with each anchor flange 926 are always in engagement with the tapered edges 932 of the wear plates 934 to support the knife holder assemblies 908. The hydraulically actuated wedges 930 associated with each anchor flange 926 are selectively engaged or disengaged with the tapered edges 932 of the wear plates 934 in response to extension or retraction of the piston associated with each hydraulic piston/cylinder mechanism 928. When the respective pistons are retracted, the wedges 930 are brought into engagement with the tapered edges 932 of the wear plates 934 to fix the position of the knife holder assemblies 908 along the lengths of the upper and lower arbors 904, 906.

One of the fixed or stationary threaded shafts 912, 914 in the respective machine frames 902a, 902b projects through the smaller hole 922 of each retainer block 920. The ball nut 916 is inserted Into a sleeve positioned in the smaller hole 922 of each retainer block 920. The ball nut 916 is threadably coupled to the threaded shaft 912 or 914 and is fastened to the sleeve so that the ball nut 916 and sleeve are free to rotate relative to the fixed or stationary threaded shafts 912, 914. An opening is provided in the sleeve to accommodate the ball nut 916. A presently preferred embodiment of the ball nut 916 Is commercially available from Thomson-Saginow (www.thomsonind.com) as Catalog Part No. 5704271.

The ball nut 916 is coupled by a gear belt 936 to the positioning motor 918 mounted by a pivot mount to an upper arm of the retainer block 920. The positioning motor 918 is mounted by the pivot mount on a tension plate and a tension adjustment mechanism allows for the accurate positioning of the positioning motor 918 and tension plate on the retainer block 920. Appropriate tension on the gear belt 936 coupled to the output shaft of the positioning motor 918 Is maintained by the tension adjustment mechanism.

Each positioning motor 918 of the knife holder assemblies 908 is electrically coupled to the programmable logic controller (not shown) as described in detail above in connection with the CNC slitting machine 100 of FIGS. 1A-1B. The programmable logic controller is likewise electrically coupled to the HMI interface described in detail above In connection with the CNC slitting machine 100 of FIGS. 1A-1B. Each positioning motor 918 receives instructions from the programmable logic controller (not shown) according to inputs entered by the operator through the HMI Interface (not shown) and, upon actuation, the respective positioning motors 918 rotate the gear belt 936 trained around the output of the positioning motor 918 and the ball nut 916. Rotation in the appropriate direction of the positioning motor 918 output shaft and likewise the ball nut 916 that is threadably coupled to the fixed or stationary threaded shaft 912 or 914 moves the knife holder assembly 908 relative to the threaded shaft 912 or 914 to the appropriate position.

Each upper and lower arbor 904, 906 includes a keyway 938 projecting radially inwardly from the outer circumference of the arbors 904, 906. The keyway 938 Is sized and configured to receive a key 940 projecting radially inwardly from an arbor 942 seated within the large hole 924 in the retainer block 920. The arbor 942 Is therefore coupled to the upper or lower arbors 904, 906 for rotation with the upper or lower arbors 904, 906 relative to the retainer block 920. Likewise, the arbor 942 has the rotary disk-shaped knife 910 with a pair of stripper plates mounted on the opposite faces of the knife 910 for rotation with the arbor 942. The stripper plates and knife 910 are mounted by bolts or otherwise to the arbor 942 for rotation with the upper and lower arbors 904, 906. Ball bearings are provided between sleeve and retaining block 920 at the smaller upper hole 922 and bearings are likewise provided between the inner surface of the larger hole 924 in the retainer block 920 and the arbor 942. Spacers and ball bearings are included to allow for the free rotational movement of the arbor 942 relative to the knife holder assembly retainer block 920. As such, rotation of the upper and lower arbors 904, 906 drives the arbors 942 and associated stripper plates and knives 910 for slitting of the metal sheet.

The knife holder assemblies 908, arbors 942 and knives 910 are not supported by the upper and lower arbors 904, 906. Rather, the knife holder assemblies 908 are supported for movement along the upper and lower arbors 904, 906 through cooperation of the wedges 930 with the upper and lower wear plates 934. In this way, the upper and lower drive arbors 904, 906 are torsional members only to provide torque to the knives 910. The upper and lower arbors 904, 906, therefore, do not take any separating load during the slitting operation since the load is transmitted from the knife holder assemblies 908 to the upper and lower frames 902a, 902b.

The movement of each knife holder assembly 908 along the upper and lower arbors 904, 906 to a desired position is controlled through Inputs applied to the positioning motors 918 from the programmable logic controller (not shown). A pair of upper and lower linear encoders (not shown) associated with the upper and lower knife holder assemblies 908 provide inputs to the programmable logic controller to indicate the position of each knife holder assembly 908 along the respective upper and lower arbors 904, 906. Each linear encoder (not shown) includes an elongated scale (not shown) that is supported by the upper and lower frames 902a, 902b and scanning units (not shown) that are each mounted to one of the knife holder assemblies 908. The scanning units (not shown) are electrically coupled to the controller and are operable to read a scale housed within each linear encoder and provide scale data to the programmable logic controller (not shown) so that the position of each knife holder assembly 908 is monitored and controlled by the controller in a closed-loop feedback control.

The knife holder assemblies 908 can be accurately, efficiently and safely positioned in the respective upper and lower machine frames 902a, 902b by a user inputting appropriate data through the HMI interface (not shown). The input data may include the number of desired mults, the desired width of each mutt, the material thickness of sheet, the desired percentage of horizontal gap between cooperating upper and lower knives 910, the desired relative vertical position of the upper and lower knives 910 and the desired offset distance from centerline, although other Inputs are possible as well without departing from the spirit and scope of the present invention. This information is then processed in the programmable logic controller which sends appropriate instructions to each of the positioning motors 918 to cause rotation of the respective ball nuts 916 and thereby position the knife holder assemblies 908 along the upper and lower arbors 904, 906 as appropriate. The programmable logic controller also actuates the jack screw motor (not shown) described in detail above in connection with CNC slitting machine 300 of FIGS. 3A-3B to adjust the Jack screws 304 and thereby achieve the desired relative vertical position of the upper and lower knives 910.

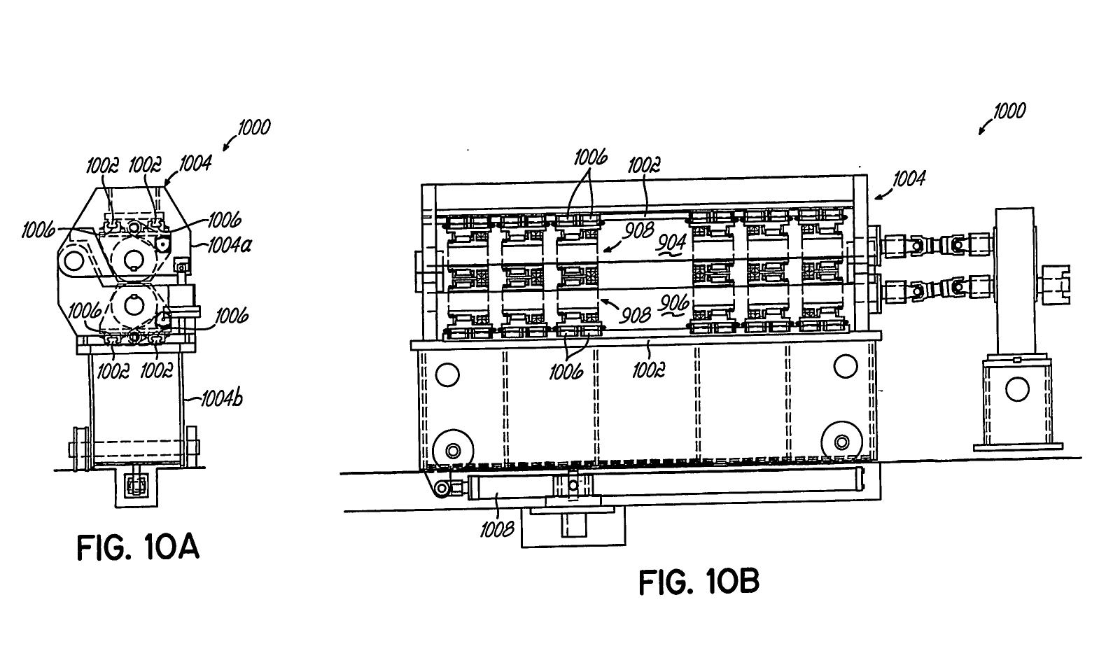

Referring now to FIGS. 10A-10B, a CNC slitting machine 1000 in accordance with a tenth embodiment of the present invention Is shown, where like numerals represent like parts to the CNC slitting machine 900 of FIG. 9. In this embodiment, the wear plates 934 and hydraulic piston/cylinder mechanisms 928 of CNC slitting machine 900 have been replaced with rails 1002 that extend the length of the frame 1004 and linear bearing blocks 1006 mounted to each of the anchor flanges 926. The frame 1004 includes upper and lower frames 1004a, 1004b that pivot relative to each other as described in detail above in connection with CNC slitting machine 300 of FIGS. 3A-3B.

A pair of linear bearing blocks 1006 are mounted in spaced relationship to each of the anchor flanges 926 in either an inboard or outboard position. Each linear bearing block 1006 is sized and configured to capture one of the rails 1002 which extend lengthwise on the slitting machine 1000 and which are provided in inner and outer rail pairs to support the knife holder assembles 908. More specifically, a pair of upper inner rails 1002, a pair of upper outer rails 1002, a pair of inner lower rails 1002 and a pair of outer lower rails 1002 are provided on the machine 1000 for supporting the respective knife holder assemblies 908.

Each knife holder assembly 908 is coupled through the linear bearing blocks 1006 to each of the rails 1002 in one of the Inner or outer rail pairs. The inner and outer rails 1002 on the upper and on the lower frame 1004a, 1004b of the machine 1000 advantageously allow for more intimate nesting of the adjacent knife holder assemblies 908 on the upper and lower arbors 904, 906. A first knife holder assembly 908 is coupled through the linear bearing blocks 1006 to each of the rails 1002 on the inner pair of the respective upper or lower machine frames 1004a, 1004b. The knife holder assemblies 908 adjacent to the first are coupled through their respective linear bearing blocks 1002 to the rails 1002 of the outer pair to avoid Interference with the first knife holder assembly 908 and allow for close pack nesting of the adjacent knife holder assemblies 908 and slitting of the metal sheet for relatively narrow mults.

As shown on the left side of FIG. 10B, the frame 1004 is operable to be traversed through extension of a hydraulic piston/cylinder mechanism 1008. The appropriate knife holder assembly 908 can be conveniently and efficiently moved toward the end of the upper and lower arbors 904, 906 for repair, replacement or servicing.

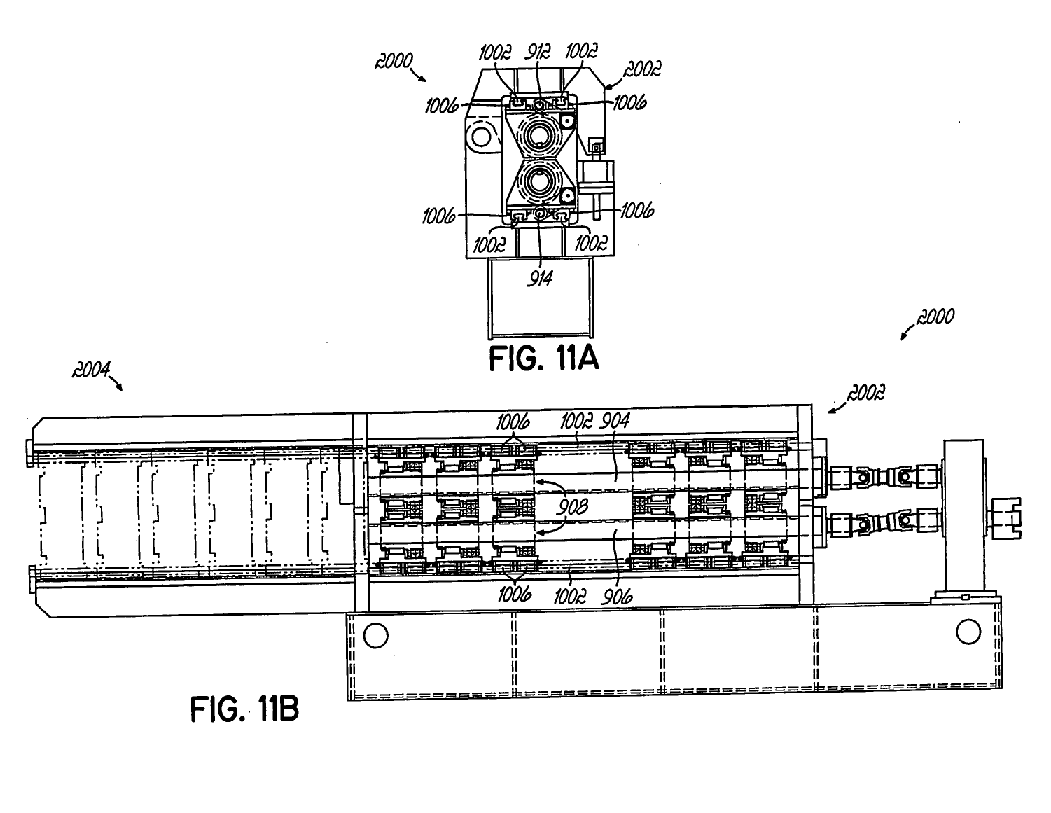

Referring now to FIGS. 11A-11B, a CNC slitting machine 2000 in accordance with an eleventh embodiment of the present invention is shown, where like numerals represent like parts to the CNC slitting machine 1000 of FIG. 10. In this embodiment, and as shown on the left side of FIG. 11B, the frame 2002 includes a storage section 2004 for storing knife holder assemblies 908 when not in use. The upper and lower arbors 904, 906, upper and lower threaded shafts 912, 914 and upper and lower pairs of rags 1002 extend within the storage section 2004 to permit movement of the knife holder assemblies 908 between the slitting machine 2000 and the storage section 2004.

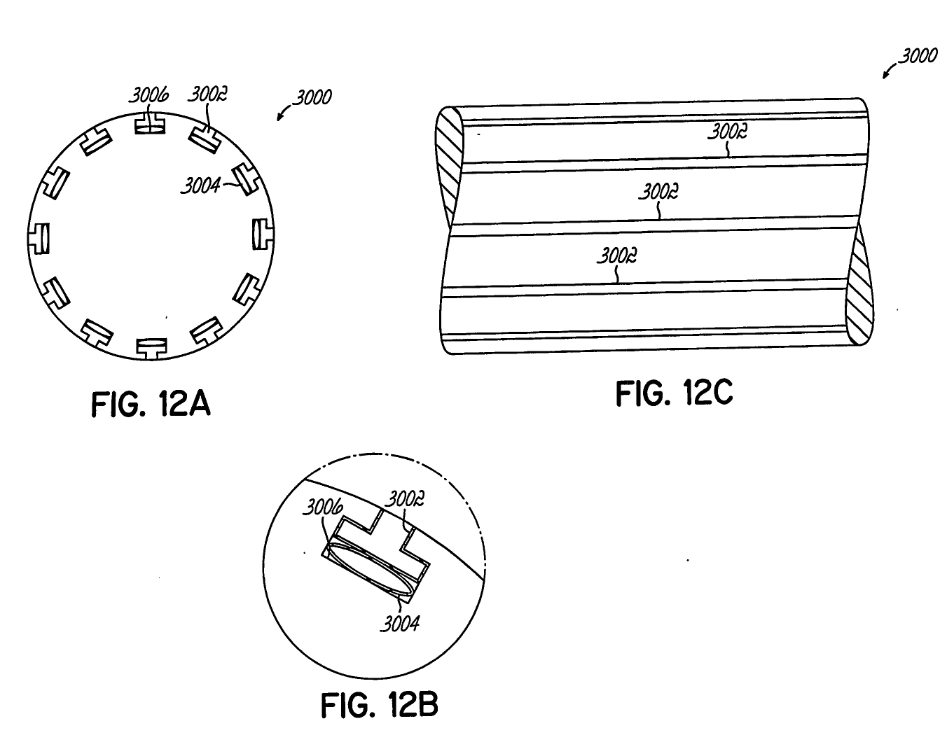

Referring now to FIGS. 12A-12B, an alternative expansion arbor 3000 for use in the slitting machines of the present invention Is shown. The arbor 3000 defines a plurality of circumferentially spaced and axially-extending slots 3002 along its length. A radially outwardly directed ram is positioned in each of the slots 3002 and an Inflatable tube 3004 is positioned in each of the slots 3002 between the ram and an inner radial face 3006 of the slot 3002. The inflatable tubes 3004 are inflated with either hydraulic or pneumatic pressure to force the rams radially outwardly relative to the exterior surface of the arbor 3000 to engage the inner surfaces of the knife hubs to fix the location of the knife hubs along the length of the arbor 3000.

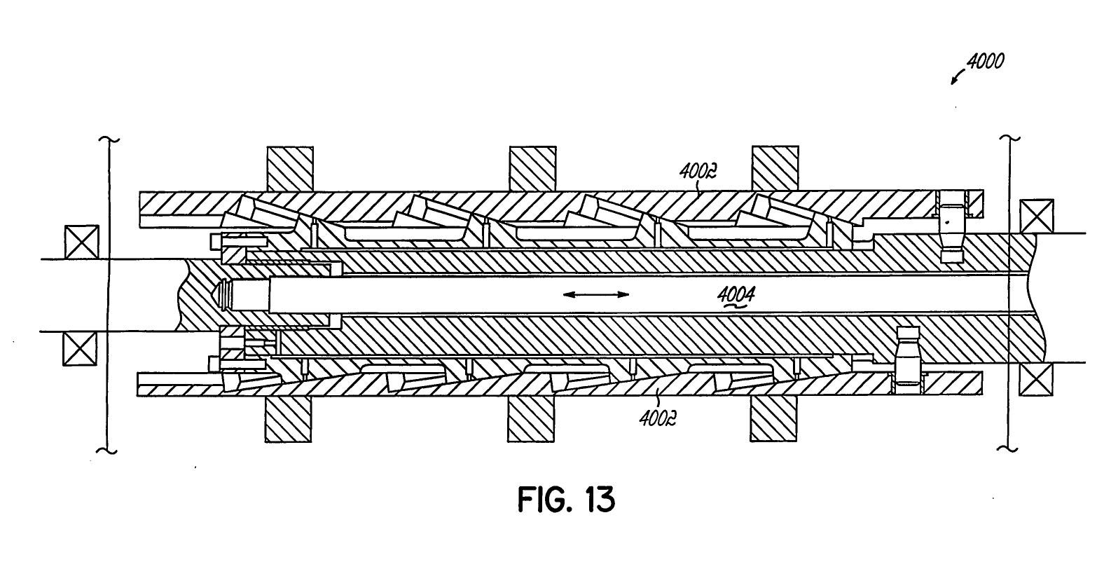

Referring now to FIG. 13, another alternative expansion arbor 4000 for use in the slitting machines of the present invention is shown. In this embodiment, the arbor 4000 includes a plurality of circumferentially spaced and axially extending wedges 4002 along its length. A rotating hydraulic cylinder 4004 is positioned within the arbor 4000 and is operable to move axially in opposite directions within the arbor 4000. Rotation of the hydraulic cylinder in one direction causes the wedges 4002 to expand radially outwardly to engage the inner surfaces of the knife hubs to fix the location of the knife hubs along the length of the arbor 4000. Rotation of the hydraulic cylinder in an opposite direction causes the wedges 4002 to retract radially inwardly to disengage from the inner surfaces of the knife hubs to permit movement of the knife hubs along the length of the arbor 4000.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

1. A machine for slitting a metal sheet comprising:
a frame;
an upper arbor mounted for rotation In the frame;
a lower arbor mounted for rotation in the frame;
a drive motor operably coupled to the upper and the lower arbors for rotation of the upper and lower arbors;
a plurality of knife assemblies supported for movement along the upper and lower arbors such that a first knife assembly is supported for movement along the upper arbor and a second knife assembly Is supported for movement along the lower arbor,
a plurality of rotary knives each being mounted in one of the knife assemblies and driven by one of the upper and lower arbors;
wherein the knives of the first and second knife assemblies cooperate to slit the metal sheet passing through a nip between the knives of the respective knife assemblies;
an upper knife assembly positioning device including a pair of oppositely disposed contact members operable to releasably grasp each of the first knife assemblies for movement of the first knife assemblies along the upper arbor, ‘a lower knife assembly positioning device Including a pair of oppositely disposed contact members operable to releasably grasp each of the second knife assemblies for movement of the second knife assemblies along the lower arbor;
a first drive mechanism associated with the upper knife assembly positioning device and operable to move the first knife assemblies along the upper arbor; and
a second drive mechanism associated with the lower knife assembly positioning device and operable to move the second knife assemblies along the lower arbor.

2. The machine of claim 1 wherein each pair of oppositely disposed contact members of the respective upper and lower knife positioning devices are operable to move toward and away from each other to releasably grasp a respective one of the plurality of knife assemblies.

3. The machine of claim 1 wherein each contact member includes a pair of side-by-side contact devices operable to releasably grasp a portion of a respective rotary knife.

4. The machine of claim 3 wherein the pair of side-by-side contact members are operable to move toward and away from each.

5. The machine of claim 1 wherein each of the knife assemblies includes a pair of collar members and a pair of fastener members joining the pair of collar members.

6. The machine of claim 5 wherein each of the upper and lower knife assembly positioning devices supports at least one tightening member which is operable to releasably engage the fastener members to tighten the respective collars and thereby secure the knife assemblies at predetermined positions along the respective upper and lower arbors.

7. The machine of claim 1 wherein each of the upper and lower arbors include a pair of slots extending lengthwise of the respective upper and lower arbors.

8. The machine of claim 7 wherein each of the knife assemblies includes a pair of screw members that engage the respective upper and lower arbors within the respective pair of slots.

9. The machine of claim 8 wherein each of the upper and lower knife assembly positioning devices supports at least one tightening member which is operable to releasably engage the screw members to tighten the screw members into engagement with the respective slots and thereby secure the knife assemblies at predetermined positions along the respective upper and lower arbors.

10. The machine of claim 1 wherein each of the upper and lower arbors Include a pair of planar surfaces extending lengthwise of the respective upper and lower arbors.

11. The machine of claim 10 wherein each of the knife assemblies Includes a pair of screw members and a pair of wedge members associated the pair of screw members.

12. The machine of claim 11 wherein each of the upper and lower knife assembly positioning devices supports at least one tightening member which is operable to releasably engage the screw members to tighten the screw members into engagement with the respective wedge members and urge the wedge members into frictional engagement with the planar surfaces of the respective upper and lower arbors to thereby secure the knife assemblies at predetermined positions along the respective upper and lower arbors.

13. The machine of claim 1 wherein each of the upper and lower arbors is hollow.

14. The machine of claim 13 further comprising a plurality of backup rolls mounted to engage the circumference of the rotary knives.

15. The machine of claim 1 wherein each of the upper and lower arbors comprises an expandable arbor.

16. The machine of claim 1 wherein a portion of the frame is operable to disengage from respective ends of the upper and lower arbors.

17. The machine of claim 1 wherein the frame further comprises:
an upper frame in which the upper arbor is rotatably mounted; and
a lower frame coupled to the upper frame and in which the lower arbor is rotatably mounted.

18. The machine of claim 17 wherein the upper frame is pivotally coupled to the lower frame.

19. The machine of claim 18 further comprising a pair of Jack screws each mounted between the upper and lower frames for adjusting relative vertical positioning of the rotary knives in a direction generally perpendicular to the axes of the upper and lower arbors.
